(19) United States
(12) Patent Application Publication
(10) Pub. No.: US 2009/0299534 A1
(43) Pub. Date: Dec. 3, 2009

(54) START/STOP TEMPERATURE CONTROL OPERATION

(75) Inventor: Bradley M. Ludwig, Minnetonka, MN (US)

Correspondence Address: MICHAEL BEST & FRIEDRICH LLP, 100 E WISCONSIN AVENUE, Suite 3300, MILWAUKEE, WI, 53202, US

(73) Assignee: THERMO KING CORPORATION, Minneapolis, MN (US)

(21) Appl. No.: 12/474,762

(22) Filed: May 29, 2009

Related U.S. Application Data
(60) Provisional application No. 61/057,605, filed on May 30, 2008.

(51) Int. Cl. G05B 15/00; F25B 1/00

(52) U.S. Cl. 700/278; 62/498

(57) ABSTRACT

An environmentally controlled shipping container including a storage space and a refrigeration system that includes a prime mover, a compressor driven by the prime mover and providing a flow of refrigerant, a condenser that receives the flow of refrigerant from the compressor, an evaporator in heat exchange relation with the storage space to remove heat from air supplied to the storage space. A controller operates the refrigeration system in one of a continuous mode wherein the prime mover operates continuously, a standard start/stop mode wherein the prime mover operates intermittently such that while the prime mover is operating in the standard start/stop mode the compressor provides a maximum flow of refrigerant, and a modulated start/stop mode wherein the prime mover operates intermittently such that while the prime mover is operating in the modulated start/stop mode the operating parameters of the refrigeration system may be modulated.

### RELATED APPLICATIONS

This patent application claims priority to U.S. Provisional Patent Application Ser. No. 61/057,605 filed May 30, 2008, the contents of which are hereby incorporated by reference in their entirety herein.

### BACKGROUND

The present invention relates to transport refrigeration units. Specifically, the invention relates to start/stop temperature control modes for operating transport refrigeration units.

Typical Transport Refrigeration Units (TRU's) feature a start/stop temperature control mode and a continuous mode. Start/stop temperature control mode is used for maximum fuel economy and also minimizes run time of the TRU system. Continuous mode is used for applications requiring constant air flow and precise temperature control. Continuous mode is further subdivided into modulated and non-modulated operation. During modulated operation the TRU's capacity is controlled to match a cargo container's heat load. For example, the cargo container will have a higher heat load when full than when empty. Continuous mode requires operation of the TRU's prime mover and refrigeration system in order to facilitate continuous air flow. Operating the TRU with the continuous mode requires a significant increase in fuel consumption.

### SUMMARY

During typical start/stop temperature control mode operation the TRU will automatically start and stop based on defined switch points. While the TRU is running, typical units operate in the full cool or full heat mode. This creates multiple problems when hauling temperature sensitive commodities and products. For example, during light load operation the refrigeration system will quickly satisfy the temperature requirements of a conditioned space within the cargo container. This can lead to product damage because the short duration of unit operation does not provide adequate or sustained airflow to all locations within the conditioned space. This can lead to localized product degradation. During operation at moderate and heavy loads, the extended run time of the unit can lead to product damage due to low or high discharge air (i.e., supply air) temperatures. During operation at heavy loads, the hot or cold spots can develop in the conditioned space which can lead to localized product damage. These characteristics have resulted in the general industry practice of using continuous operation for the transport of temperature sensitive products.

The invention is a third method of transport refrigeration temperature control operation. The method allows a user to capture much of the fuel saving benefit and reduced run time associated with typical start/stop temperature control mode operation while providing improved temperature control. The method allows the user to program selected attributes of the temperature control including the minimum discharge air temperature, the maximum amount of time between automatic restarts, and the minimum amount of time between automatic restarts. The method will automatically force the unit to high speed to minimize the potential for product freeze damage and will automatically force the unit to high speed to insure that the unit reaches the programmed temperature setpoint under all load conditions. During the period where the unit runs to maintain the engine starting battery and minimum engine coolant temperature, the unit continues to maintain the programmed temperature control limits.

In one embodiment, the invention provides an environmentally controlled shipping container that includes a storage space and a refrigeration system that includes a prime mover, a compressor driven by the prime mover and providing a flow of refrigerant, a condenser that receives the flow of refrigerant from the compressor, an evaporator in heat exchange relation with the storage space and in fluid communication with the condenser such that the evaporator receives the flow of refrigerant from the condenser and removes heat from air supplied to the storage space. A controller operates the refrigeration system in one of a continuous mode wherein the prime mover operates continuously, a standard start/stop mode wherein the prime mover operates intermittently such that while the prime mover is operating in the standard start/stop mode the compressor provides a maximum flow of refrigerant, and a modulated start/stop mode wherein the prime mover operates intermittently such that while the prime mover is operating in the modulated start/stop mode the operating parameters of the refrigeration system may be modulated. When operating in the modulated start/stop mode, the controller utilizes a user entered limit temperature such that the temperature of air supplied to the storage space cannot exceed the limit temperature.

In another embodiment, when operating in the modulated start/stop mode, the controller utilizes a timer and a user defined time limit and starts the refrigeration system after the timer indicates the expiration of the user defined time limit.

In another embodiment, the invention allows user programmed control of the minimum discharge air temperature during start/stop temperature control operation. The TRU will maintain the programmed operating parameters in both low speed diesel, high speed diesel, and electric standby operation.

In another embodiment, when operating in the modulated start/stop mode, the controller automatically operates the refrigeration system in a high speed mode based at least in part on a user defined product risk factor. Product damage is minimized by increasing capacity to decrease the amount of time before the TRU reaches the programmed temperature set point. Alternatively, the increased capacity allows for a relatively lower air temperature to achieve the same overall cooling, thereby presenting less likelihood of damage due to cold air stratification.

In another embodiment, when operating in the modulated start/stop mode, the controller utilizes a measured temperature within the storage space and a timer to determine a rate of temperature change, and the controller is operable to change the refrigeration system to a high speed mode from a normal speed mode if the rate of temperature change is outside a user defined range.

In another embodiment, the invention maintains the programmed temperature limits during operation when the unit is forced to run to charge the engine starting battery or maintain the engine coolant temperature.

Other aspects of the invention will become apparent by consideration of the detailed description and accompanying drawings.

### BRIEF DESCRIPTION OF THE DRAWINGS

FIG. 1 is a schematic representation of a trailer and a transport refrigeration unit according to the invention.

FIG. 2 is a flow chart of a method utilized by the transport refrigeration unit of FIG. 1.

FIG. 3 is another flow chart of a method utilized by the transport refrigeration unit of FIG. 1.

FIG. 4 is another flow chart of a method utilized by the transport refrigeration unit of FIG. 1.

FIG. 5 is another flow chart of a method utilized by the transport refrigeration unit of FIG. 1.

FIG. 6 is another flow chart of a method utilized by the transport refrigeration unit of FIG. 1.

FIG. 7 is another flow chart of a method utilized by the transport refrigeration unit of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

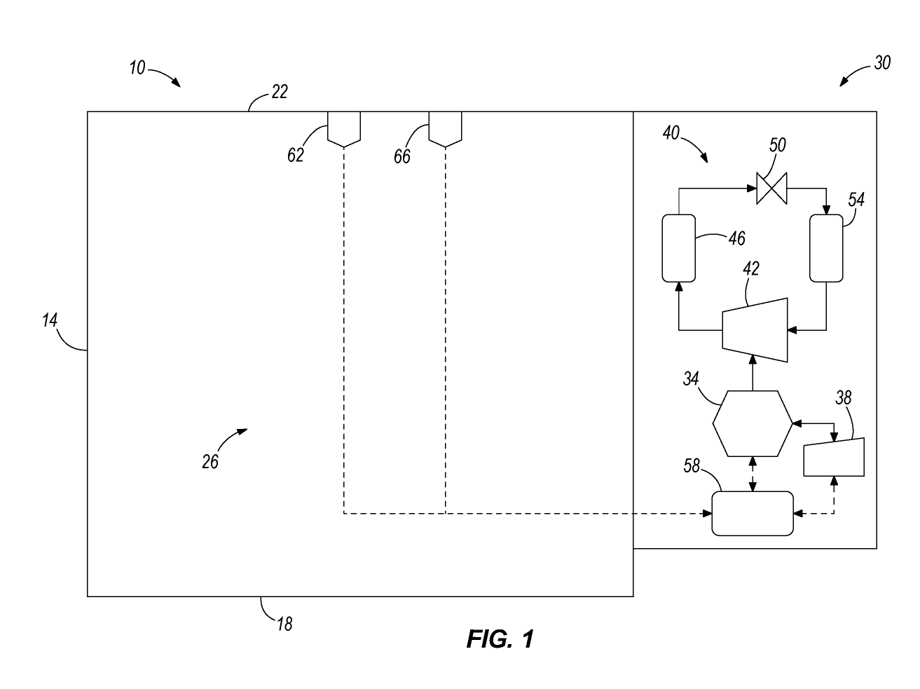

FIG. 1 schematically illustrates shipping container in the form of a trailer 10 used for shipping temperature sensitive products. The trailer 10 is of the type that are attached to a vehicle (not shown) for transport over land or sea. For example, the trailer 10 may be hauled over land by a truck. The illustrated trailer 10 includes four side walls 14, a floor 18, a roof 22, and two doors (not shown). The side walls 14, the floor 18, the roof 22 and the doors define a temperature controlled space 26 within the trailer 10. The illustrated trailer 10 includes an insulation layer (not shown) that inhibits heat transfer from the temperature controlled space 26 to the ambient environment outside the trailer 10. In other embodiments, the trailer 10 may have more or less doors, an open roof, vented side walls, a rolling floor, different insulation, and other configurations, as desired. In another embodiment, the shipping container may be a container for over-sea shipping, air-freight shipping, railroad transport, or another form of container, as desired.

With continued reference to FIG. 1, a transport refrigeration unit (TRU) 30 is attached to the trailer 10. The TRU 30 may be built into the trailer 10, may be an attached unit, or may be removably attached to the trailer 10. The illustrated TRU 30 is attached to the trailer 10 with fasteners. The TRU 30 includes a prime mover 34, a battery 38, and a refrigerant circuit 40 that includes a compressor 42, a condenser 46, an expansion valve 50, an evaporator 54, and a controller 58.

The illustrated prime mover 34 is a diesel engine that powers the compressor 42. In other embodiments, the prime mover 34 may be the vehicle engine or a gasoline engine. In addition, the compressor 42 could be driven by an electric motor that is powered by the battery 38. Furthermore, the prime mover 34 could be an electric motor that receives power from a generator coupled to the vehicle engine or another engine. In still other embodiments, the motor could be powered from a stationary electrical grid. Other arrangements are possible and may be implemented, as desired.

The illustrated battery 38 is electrically connected with the prime mover 34. The battery 38 provides power to start the prime mover 34, and while the prime mover 34 is running, the battery is charged. The battery 38 powers the controller 58 and other systems (e.g., a human machine interface (HMI), sensors, timers, etc.), as desired.

The illustrated compressor 42 is directly driven by the prime mover 34 and compresses a refrigerant such that it flows through the condenser 46, expansion valve 50, and evaporator 54 to cool the evaporator 54 such that air passing over the evaporator 54 is conditioned before it passes into the temperature controlled space 26. The refrigerant circuit 40 operates to heat or cool the air entering the temperature controlled space 26. In other embodiments, the refrigerant circuit 40 may include an air-filtration system, a spray system for ripening agents or other products, or other components, as desired.

The controller 58 operates the TRU 30 in a variety of modes that may be selected by a user and is in communication with the prime mover 34, the battery 38, a return air sensor 62, and a supply air sensor 66. The return air sensor 62 is positioned such that it detects and reports to the TRU 30 the temperature of air returning from the temperature controlled space 26 (i.e., a return air temperature T_{RA}). The supply air sensor 66 is positioned such that it detects the temperature of air supplied from the TRU 30 to the temperature controlled space 26 (i.e., a supply air temperature T_{SA}). In addition, the controller 58 may communicate with other sensors and/or components of the vehicle, the TRU 30, and/or the trailer 10.

A first mode of operation is a continuous mode wherein the controller 58 maintains the TRU 30 in a constant running state and modifies the heating and cooling levels to accurately maintain the temperature within the temperature controlled space 26. This type of control produces an accurate temperature by varying the speed of the prime mover 34 or the air flow into the temperature controlled space 26 but requires the prime mover 34 to run constantly and therefore consumes a large amount of fuel when compared to non-continuous operation. Details of continuous mode operation will not be discussed in detail herein.

A second mode of operation is a start/stop temperature control mode wherein the controller 58 maintains a setpoint temperature or temperature band within the temperature controlled space 26 by cycling the TRU 30 on and off with heating and/or cooling. Within the start/stop temperature control mode, the invention provides a standard start/stop temperature control mode and a modulated start/stop temperature control mode that includes a modulated heat mode (MHM), a modulated cool mode (MCM), a high speed cool modulation mode (HSMD), and a defrost mode. Other modes may exist and be utilized by the controller to condition the air within the temperature controlled space 26, as desired.

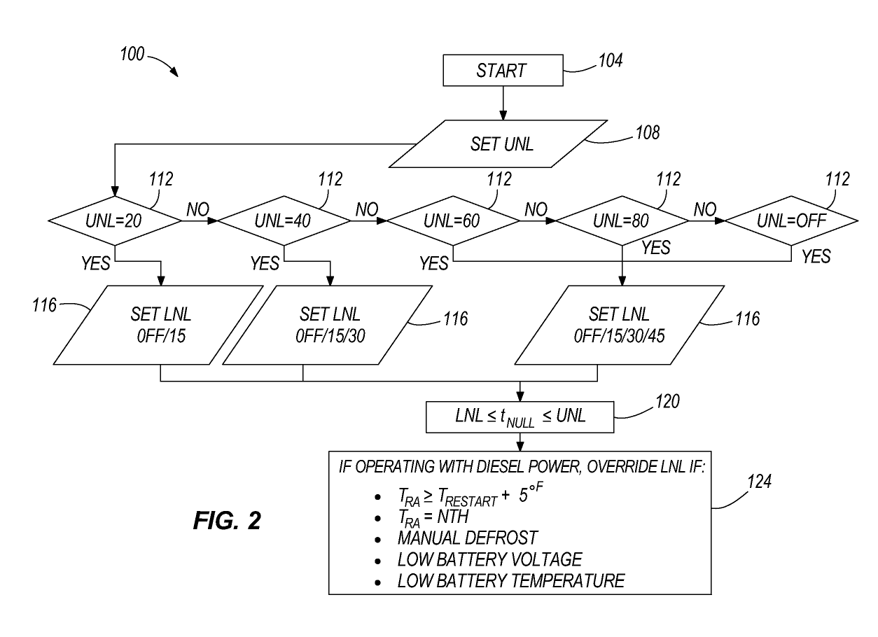

Operation of the TRU 30 will be described hereunder with respect to FIGS. 2-7. In the illustrated embodiment, the TRU 30 runs while the prime mover 34 and the refrigeration circuit 40 are operating to condition the air within the temperature controlled space 26, and the TRU 30 is null while the prime mover 34 and the refrigeration circuit 40 are not operating. While the TRU 30 is in a null state, the controller 58 is still operating and monitoring the TRU 30 such that the temperature controlled space is maintained as desired.

FIG. 2 shows a method 100 of controlling the time between starting and stopping the TRU 30. The method is started at block 104 when the TRU 30 is started. At block 108, the controller 58 prompts a user to enter an upper null limit time UNL that defines the maximum time the TRU 30 may be null. In the illustrated embodiment, the user may select OFF, twenty, forty, sixty, or eighty minutes. If the user attempts to select a time not listed, the controller 58 will round to the nearest acceptable selection. In other embodiments, other times may be available or any time may be selected, as desired.

After the UNL is selected, the controller 58 determines which selection was made at blocks 112 and then continues to block 116, where the user is prompted to select a lower null limit time LNL that defines the minimum time the TRU 30 may be null. In the illustrated embodiment, the user may select OFF, fifteen, thirty, or forty-five minutes. If the user attempts to select a time not listed, the controller 58 will round to the nearest acceptable selection. In addition, the controller 58 only allows the user to select a LNL that is lower than the UNL. For example, the user may not select an UNL of twenty minutes and a LNL of forty-five minutes. In other embodiments, other times may be available or any time may be selected, as desired.

The time that the TRU 30 is null is defined as the null time tₙᵤₗₗ. The controller 58 determines the null time tₙᵤₗₗ at block 120 such that the null time tₙᵤₗₗ is greater than or equal to the selected LNL and less than or equal to the UNL. For example, if the user selects a sixty minute UNL and a thirty minute LNL, the TRU 30 will operate in a null state for between thirty and sixty minutes. In other words, the controller inhibits the TRU 30 from running before thirty minutes of null operation have passed, and forces the TRU 30 to run after sixty minutes have passed.

As previously stated, the controller 58 continues to monitor the TRU 30 and trailer 10 during null operation. If during the null operation, the controller 58 determines an override command is appropriate, the LNL may be disabled such that the controller 58 may run the TRU 30 before the minimum amount of null time tₙᵤₗₗ has passed. In the illustrated embodiment, the override command is signaled at block 124 when the return air temperature T_{RA} is greater than or equal to a restart temperature Tᵣₑₛₜₐᵣₜ plus a temperature threshold (e.g., five degrees Fahrenheit), the return air temperature T_{RA} reaches a null restart temperature switch-point NRS, a manual defrost command is received, the controller 58 recognizes a low battery voltage condition wherein the battery 38 has a substantially low charge, or if the controller 58 recognizes the prime mover 34 coolant temperature is below a predetermined threshold value. If one of the override conditions is met, the controller 58 ignores the LNL and operates the TRU 30 accordingly. The controller 58 may recognize different override conditions not listed herein, as desired.

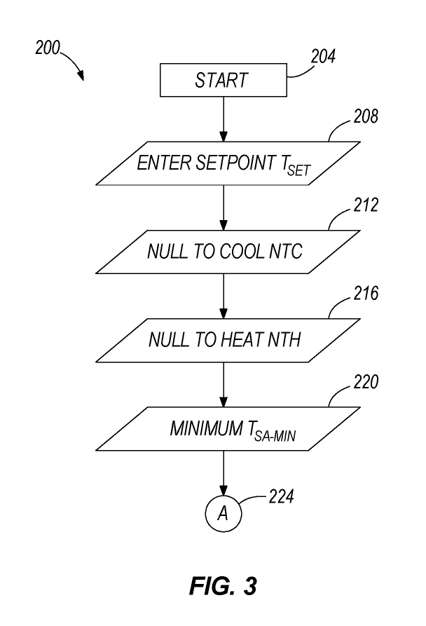

With reference to FIG. 3, after the controller 58 has utilized the method 100 and determined the appropriate null time tₙᵤₗₗ, the method 200 is executed. After the controller 58 initiates the method 200 at block 204, the user is prompted for a setpoint temperature Tₛₑₜ at block 208. The setpoint temperature Tₛₑₜ represents the temperature the TRU 30 will maintain within the temperature controlled space 26. The illustrated modulated start/stop temperature control mode is intended for setpoint temperatures between six and fifteen degrees Fahrenheit. In other embodiments, different ranges of the setpoint temperature Tₛₑₜ may be desirable.

The controller 58 subsequently prompts the user for a null to cool temperature switch point (NTC) at block 212, a null to heat temperature switch point (NTH) at block 216, and a minimum supply air temperature T_{SA-min} at block 220. The controller 58 may utilize more inputs and may include other setpoints, as desired.

The NTC defines the temperature at which the TRU 30 will operate the MCM to cool the air within the temperature controlled space 26. For example, if the temperature setpoint Tₛₑₜ is twelve degrees Fahrenheit, and the NTC is eighteen degrees Fahrenheit, the TRU 30 will not operate the MCM until the temperature within the temperature controlled space 26 reaches eighteen degrees. When the NTC is reached, the TRU 30 runs to cool the air within the temperature controlled space 26 back to the setpoint temperature Tₛₑₜ.

The NTH defines the temperature at which the TRU 30 will operate the MHM to heat the air within the temperature controlled space 26. For example, if the temperature setpoint Tₛₑₜ is fifteen degrees Fahrenheit, and the NTH is ten degrees Fahrenheit, the TRU 30 will not operate the MCM until the temperature within the temperature controlled space 26 drops to ten degrees. When the NTH is reached, the TRU 30 runs to heat the air within the temperature controlled space 26 back up to the setpoint temperature Tₛₑₜ.

The minimum supply air temperature T_{SA-min} defines the coldest air that may be supplied to the temperature controlled space 26 from the TRU 30. The illustrated minimum supply air temperature T_{SA-min}, or floor limit, is programmable in one degree increments and has a default value of ten degrees Fahrenheit (i.e., supply air is no colder than ten degrees). The minimum supply air temperature T_{SA-min} will be utilized by the controller 58 during execution of MCM, MHM, and HSMD. A freeze protection option, may add additional functionality to the minimum supply air temperature T_{SA-min} such that products carried within the temperature controlled space 26 are inhibited from being damaged by freezing. For example, when the trailer 10 is undergoing temperature pull-up/down, the minimum supply air temperature T_{SA-min} may be eliminated such that the TRU 30 can more quickly lower/raise the temperature. If temperature sensitive products are preloaded into the trailer 10, it may be advantageous to implement the minimum supply air temperature T_{SA-min} during pull-up/down to protect the product. The minimum supply air temperature T_{SA-min} may not be overridden by any other temperature setpoints during normal operation of the TRU 30. The selection of the minimum supply air temperature T_{SA-min} is based at least in part on a balance between temperature differential (e.g., the temperature difference between return air temperature T_{RA} and supply air temperature T_{SA}) to allow the TRU 30 to satisfy the cooling load and a small enough temperature differential to not damage the product within the temperature controlled space 26. This balance is a function of the product, the external heat load (e.g., ambient temperature), the internal heat load, and other parameters. The controller 58 allows customization by the user to enable satisfying these requirements on an individual basis. In other embodiments, further measures may be taken to prevent localized freezing or heating of products within the temperature controlled space 26.

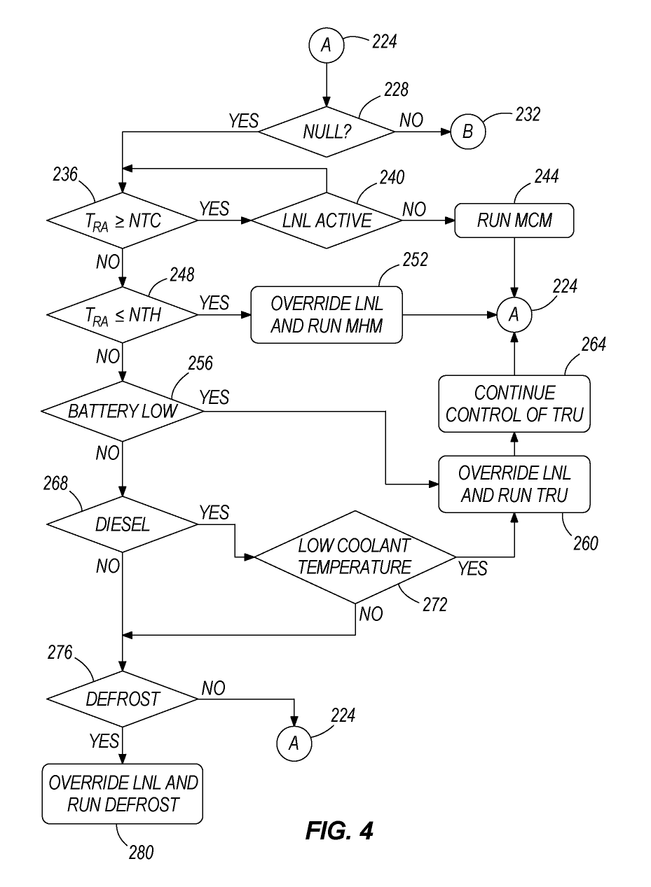

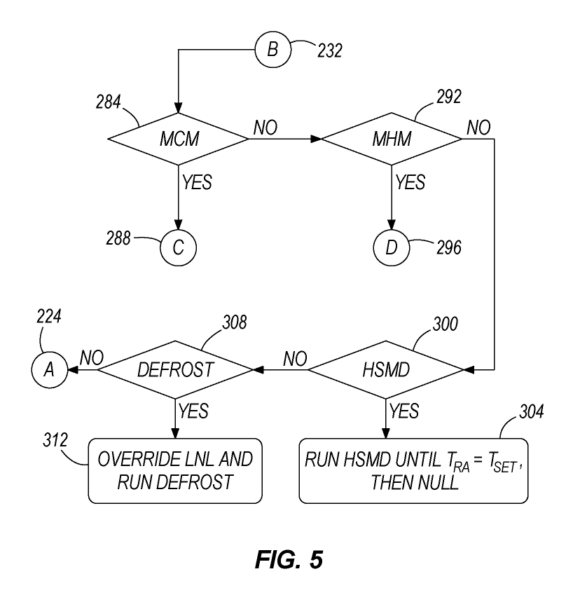

After the controller 58 receives inputs from the user at blocks 208-220, the controller 58 continues to section A of the method 200 depicted by block 224. Turning now to FIG. 4, at block 228 the controller 58 determines if the TRU 30 is null. If the TRU 30 is running (i.e., NO or not null), the controller 58 executes section B of the method 200 which starts at block 232 and is illustrated in FIG. 5. If the TRU 30 is null (i.e., YES, is null), the controller 58 then determines if it needs to run or transition out of the null state.

At block 236, the controller 58 compares the return air temperature T_{RA} (i.e., the temperature within the temperature controlled space 26) with the NTC. If the return air temperature T_{RA} is equal to or greater than the NTC, then the controller 58 determines if the LNL is active via method 100 (see FIG. 2) at block 240. If the LNL is active, the TRU 30 continues to be null and the controller 58 returns to block 236. If the LNL is not active, either because the time has elapsed or because an override signal was sent, then the controller 58 activates the MCM at block 244 and returns to section A at block 224.

If the controller 58 determines that the return air temperature T_{RA} is not greater than or equal to the NTC, then the controller 58 compares the return air temperature T_{RA} with the NTH at block 248. If the return air temperature T_{RA} is less than or equal to the NTH then the controller 58 automatically overrides the LNL and operates the TRU 30 with the MHM at block 252. After initiating operation with MHM, the controller returns to section A at block 224.

If the controller 58 determines that the return air temperature T_{RA} is not greater than or equal to the NTC, and not less than or equal to the NTH, then the battery voltage level is checked at block 256. If the battery voltage is low, then the controller 58 automatically overrides the LNL and operates the prime mover 34 at block 260 to charge the battery 38. While the prime mover 34 is operating to charge the battery 38 the controller 58 continues to execute the methods 100 and 200 at block 264 such that the temperature within the temperature controlled space 26 is maintained. When the controller 58 recognizes that the battery voltage has reached a suitable level of charge, the LNL is restored and the TRU 30 operates normally. The illustrated controller 58 continues to modulate the operation of the TRU 30 while charging the battery 38.

If the controller 58 determines that the battery voltage level is acceptable, then the controller 58 confirms that the TRU 30 is operating under diesel power via the prime mover 34 at block 268. If the TRU 30 is operating under diesel power, the temperature of the engine coolant is measured at block 272. If the controller 58 determines that the coolant temperature is below a predetermined threshold, the controller automatically overrides the LNL and runs the prime mover 34 at block 260 to raise the temperature. While the prime mover 34 is operating to raise the coolant temperature, the controller 58 continues to execute the methods 100 and 200 at block 264 such that the temperature within the temperature controlled space 26 is maintained. When the controller 58 recognizes that the coolant temperature has reached a predetermined threshold, the LNL is restored and the TRU 30 operates normally. The illustrated controller 58 continues to modulate the operation of the TRU 30 while heating the prime mover 34.

While operating the method 200, the controller 58 continually determines if a manual defrost request has been made (e.g., the check represented at block 276). If the manual defrost request has been made by the user at any time during operation of the TRU 30, the controller automatically overrides the LNL and operates the defrost mode at block 280 to defrost the evaporator 54. While the controller 58 is utilizing the defrost mode, the TRU 30 continues to defrost the evaporator until the end of the defrost cycle. After the defrost mode has completed the defrost cycle, the controller 58 returns to section A at block 224. In the illustrated embodiment, the controller 58 continually checks for the manual defrost request. In other embodiments, the check may be done sequentially, or only at block 276. In addition, the check could be done at any other point during the operation of the TRU 30.

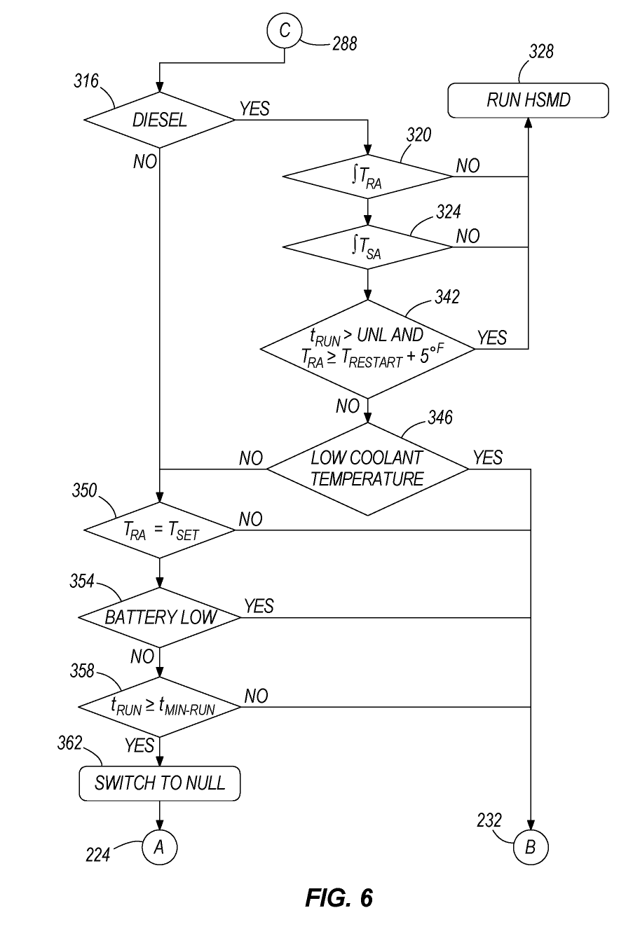

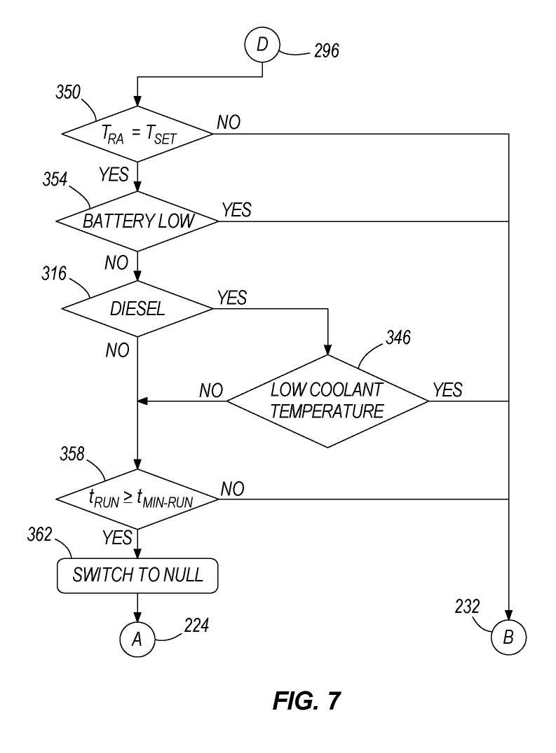

Turning now to FIG. 5, the section B of method 200 is described in detail. After the controller 58 determines that the TRU 30 is running at block 228 (see FIG. 4), the controller 58 then determines in what mode the TRU 30 is operating. If the controller 58 determines that the TRU 30 is operating in the MCM at block 284, then section C (shown in FIG. 6) of the method 200 is initiated at block 288. If the controller 58 determines that the TRU 30 is operating in the MHM at block 292, then section D (shown in FIG. 7) of the method 200 is initiated at block 296. If the controller 58 determines that the TRU 30 is operating in the HSMD at block 300, then the controller continues to run the TRU 30 in the HSMD until the return air temperature T_{RA} equals the setpoint temperature Tₛₑₜ. If the controller 58 determines that the TRU 30 is operating in the defrost mode at block 308, then the controller 58 continues to operate the TRU 30 in the defrost mode at block 312 until the defrost cycle is complete. If none of the MCM, MHM, HSMD, or defrost mode is running, then the controller 58 returns to section A of the method 200, shown in FIG. 4.

Turning now to FIG. 6, section C of method 200 is described in detail. While the controller 58 utilizes the MCM, section C is continually checked. At block 316 the controller 58 determines if the TRU 30 is powered by a diesel engine. If YES, then the controller compares integral conditions of the return air temperature T_{RA}, and the supply air temperature T_{SA} at blocks 320 and 324, respectively. The integral conditions of the return and supply air temperatures T_{RA}, T_{SA} are indicative of hot or cold spots within the temperature controlled space 26. The integral conditions are parameters that represent the balance between run time tᵣᵤₙ and the cooling potential of the TRU 30 as represented by the return air temperature T_{RA}. For example, if the TRU 30 has been running in the MCM for an extended period (e.g., forty-five minutes) and the return air temperature T_{RA} has not reached the setpoint temperature Tₛₑₜ, the controller 58 may determine that the MCM is not sufficient to effectively cool the temperature controlled space 26 and operate the TRU in the HSMD until the setpoint temperature Tₛₑₜ is reached. If the controller 58 determines that the integral conditions are not favorable to product stability, then a NO response is triggered at either block 320 or 324 and the HSMD is initiated at block 328. If both integral conditions are acceptable, then the controller 58 compares the run time tᵣᵤₙ with the UNL at block 342. If the run time has exceeded the UNL, and the return air temperature T_{RA} is greater than or equal to the restart temperature Tᵣₑₛₜₐᵣₜ plus the temperature threshold, then the controller 58 automatically initiates the HSMD such that the TRU 30 brings the temperature within the temperature controlled space 26 into an acceptable condition relatively quickly.

When the controller 58 initiates the HSMD, the TRU 30 runs in HSMD until the setpoint temperature Tₛₑₜ is reached, or a defrost mode is manually selected by the user.

If the controller 58 determines that the TRU 30 does not need to operate in the HSMD, then the coolant temperature is checked at block 346. If the coolant temperature is below the predetermined threshold then the TRU 30 continues to operate such that the coolant temperature rises as the prime mover 34 continues to run. If the coolant temperature is not below the predetermined threshold, then the return air temperature T_{RA} is compared to the setpoint temperature Tₛₑₜ at block 350. If the setpoint temperature Tₛₑₜ has been reached, then the controller 58 checks the battery charge level at block 354. If the battery charge is low, the TRU 30 continues to run such that the battery 38 is charged. If the battery charge level is acceptable, then controller 58 determines if the TRU 30 has been running for the minimum run time tᵣᵤₙ₋ₘᵢₙ at block 358. The minimum run time tᵣᵤₙ₋ₘᵢₙ may be defined by the LNL or it may be defined otherwise. In the illustrated embodiment, the minimum run time tᵣᵤₙ₋ₘᵢₙ cannot be lower than five minutes to inhibit condensation formation within the compressor in addition to other potential problems.

If all the conditions are met at blocks 350, 354, and 358 the controller 58 stops the TRU 30 and initiates a null mode at block 362. After stopping the TRU 30, the controller returns to section A of the method 200 to continue the operation of the TRU 30.

FIG. 7 shows the detail of section D of the method 200 that is similar to the section C except that section D does not include the HSMD. In the illustrated embodiment, no high speed heat modulation mode exists such that no such mode is shown in FIG. 7. However, in other embodiments, a high speed heat modulation mode may be used similar to the HSMD shown in FIG. 6. The blocks of FIG. 7 have been labeled with similar reference numbers to those of FIG. 6 and provide similar function.

In addition to the modulation modes, the TRU 30 may still operate with conventional control algorithms and includes many additional sensors and components not mentioned herein.

What is claimed is:

1. An environmentally controlled shipping container comprising:
a storage space;
a refrigeration system including a prime mover, a compressor driven by the prime mover and providing a flow of refrigerant, a condenser that receives the flow of refrigerant from the compressor, an evaporator in heat exchange relation with the storage space and in fluid communication with the condenser such that the evaporator receives the flow of refrigerant from the condenser and removes heat from air supplied to the storage space; and
a controller that operates the refrigeration system in one of a continuous mode wherein the prime mover operates continuously, a standard start/stop mode wherein the prime mover operates intermittently such that while the prime mover is operating in the standard start/stop mode the compressor provides a maximum flow of refrigerant, and a modulated start/stop mode wherein the prime mover operates intermittently such that while the prime mover is operating in the modulated start/stop mode the operating parameters of the refrigeration system may be modulated;
wherein when operating in the modulated start/stop mode, the controller utilizes a user entered limit temperature such that the temperature of air supplied to the storage space cannot exceed the limit temperature.

2. The environmentally controlled shipping container of claim 1, further comprising a sensor positioned to measure the temperature of the air supplied to the storage space, wherein the controller compares the temperature of the air sensed by the sensor to the user entered limit temperature.

3. The environmentally controlled shipping container of claim 1, wherein the controller maintains the temperature of the air supplied to the storage space relative to the user entered limit temperature.

4. The environmentally controlled shipping container of claim 1, wherein the user entered limit temperature depends on a product in the storage space, and is selected to inhibit damage to the product due to at least one of freezing and chill damage.

5. An environmentally controlled shipping container comprising:
a storage space;
a refrigeration system including a prime mover, a compressor driven by the prime mover and providing a flow of refrigerant, a condenser that receives the flow of refrigerant from the compressor, and an evaporator in heat exchange relation with the storage space and in fluid communication with the condenser such that the evaporator receives the flow of refrigerant from the condenser and removes heat from air supplied to the storage space; and
a controller that operates the refrigeration system in one of a continuous mode wherein the prime mover operates continuously, a standard start/stop mode wherein the prime mover operates intermittently such that while the prime mover is operating in the standard start/stop mode the compressor provides a maximum flow of refrigerant, and a modulated start/stop mode wherein the prime mover operates intermittently such that while the prime mover is operating in the modulated start/stop mode the operating parameters of the refrigeration system may be modulated;
wherein when operating in the modulated start/stop mode, the controller automatically operates the refrigeration system in a high speed mode based at least in part on a user defined product risk factor.

6. The environmentally controlled shipping container of claim 5, wherein the controller is operable to operate the refrigeration system in a normal speed mode, wherein when operating at high speed a higher volume of air is provided to the storage space that when operating in the normal speed mode.

7. The environmentally controlled shipping container of claim 6, wherein the air supplied to the storage space during operation in high speed mode is warmer than the air supplied to the storage space during operation in normal speed mode.

8. The environmentally controlled shipping container of claim 5, wherein the product risk factor corresponds to the susceptibility of a product to at least one of freeze and chill damage.

9. The environmentally controlled shipping container of claim 5, wherein when operating in the modulated start/stop mode, the controller utilizes a user entered limit temperature such that the temperature of air supplied to the storage space cannot exceed the limit temperature.

10. The environmentally controlled shipping container of claim 9, further comprising a sensor positioned to measure the temperature of the air supplied to the storage space, wherein the controller compares the temperature of the air sensed by the sensor to the user entered limit temperature.

11. The environmentally controlled shipping container of claim 9, wherein the controller maintains the temperature of the air supplied to the storage space relative to the user entered limit temperature.

12. The environmentally controlled shipping container of claim 9, wherein the user entered limit temperature depends on a product in the storage space, and is selected to inhibit damage to the product due to at least one of freeze and chill damage.

13. An environmentally controlled shipping container comprising:
a storage space;
a refrigeration system including a prime mover, a compressor driven by the prime mover and providing a flow of refrigerant, a condenser that receives the flow of refrigerant from the compressor, an evaporator in heat exchange relation with the storage space and in fluid communication with the condenser such that the evaporator receives the flow of refrigerant from the condenser and removes heat from air supplied to the storage space;
a temperature sensor positioned within the storage space to measure the temperature of air within the storage space; and
a controller that operates the refrigeration system in one of a continuous mode wherein the prime mover operates continuously, a standard start/stop mode wherein the prime mover operates intermittently such that while the prime mover is operating in the standard start/stop mode the compressor provides a maximum flow of refrigerant, and a modulated start/stop mode wherein the prime mover operates intermittently such that while the prime mover is operating in the modulated start/stop mode the operating parameters of the refrigeration system may be modulated;
wherein when operating in the modulated start/stop mode, the controller utilizes the measured temperature within the storage space and a timer to determine a rate of temperature change, the controller operable to change the refrigeration system to a high speed mode from a normal speed mode if the rate of temperature change is outside a user defined range.

14. The environmentally controlled shipping container of claim 13, wherein the user defined range depends on a product within the storage space.

15. The environmentally controlled shipping container of claim 13, wherein when operating in the modulated start/stop mode, the controller utilizes a user entered limit temperature such that the temperature of air supplied to the storage space cannot exceed the limit temperature.

16. The environmentally controlled shipping container of claim 13, wherein when operating in the modulated start/stop mode, the controller automatically operates the refrigeration system in the high speed mode based at least in part on a user defined product risk factor.

17. An environmentally controlled shipping container comprising:
a storage space;
a refrigeration system including a prime mover with coolant, a battery used for starting the prime mover and for operating other system components, a compressor driven by the prime mover and providing a flow of refrigerant, a condenser that receives the flow of refrigerant from the compressor, and an evaporator in heat exchange relation with the storage space and in fluid communication with the condenser such that the evaporator receives the flow of refrigerant from the condenser and removes heat from air supplied to the storage space; and
a controller that operates the refrigeration system in one of a continuous mode wherein the prime mover operates continuously, a standard start/stop mode wherein the prime mover operates intermittently such that while the prime mover is operating in the standard start/stop mode the compressor provides a maximum flow of refrigerant, and a modulated start/stop mode wherein the prime mover operates intermittently such that while the prime mover is operating in the modulated start/stop mode the refrigeration system varies the cooling capacity;
wherein when operating in the modulated start/stop mode, the controller operates the refrigeration system such that a user defined temperature is maintained within the storage space while the prime mover is running to charge the battery and/or maintain a minimum coolant temperature.

18. The environmentally controlled shipping container of claim 17, wherein when operating in the modulated start/stop mode, the controller utilizes a user entered limit temperature such that the temperature of the air supplied to the storage space cannot exceed the limit temperature.

19. The environmentally controlled shipping container of claim 17, wherein when operating in the modulated start/stop mode, the controller automatically operates the refrigeration system in the high speed cool modulation mode based at least in part on a user defined product risk factor.

20. The environmentally controlled shipping container of claim 17, wherein when operating in the modulated start/stop mode, the controller utilizes a timer and a user defined time limit; and
wherein when operating in stopped mode of the modulated start/stop mode, the controller starts the refrigeration system after the timer indicates the expiration of the user defined time limit.
